(19) United States
(12) Patent Application Publication
(10) Pub. No.: US 2012/0047744 A1
(43) Pub. Date: Mar. 1, 2012

(54) REMOVABLE STRIP FOR PACKAGING CUTLERY AND RELATED METHODS

(75) Inventor: Richard S. Walters, Port Washington, WI (US)

(73) Assignee: DIXIE CONSUMER PRODUCTS LLC, Atlanta, GA (US)

(21) Appl. No.: 13/188,533

(22) Filed: Jul. 22, 2011

Related U.S. Application Data
(60) Provisional application No. 61/376,531, filed on Aug. 24, 2010.

(51) Int. Cl. A47G 21/06; B23P 11/00; B65D 85/00

(52) U.S. Cl. 30/142; 206/553; 29/426.5

(57) ABSTRACT

An elongated apparatus for releasably retaining a plurality of utensils in a grouping includes an elongated base and at least one protrusion. The apparatus includes an elongated base having a longitudinal axis and at least one protrusion extending from the elongated base. The at least one protrusion is configured to be removably coupled to a handle end of a utensil such that coupling of the handle end occurs via movement of the handle end along an axis transverse to the longitudinal axis of the elongated base. Upon coupling of the handle end of the utensil to the at least one protrusion, the utensil is restricted from rotating about the longitudinal axis so long as the handle end of the utensil is coupled to the at least one protrusion.

### CROSS-REFERENCE TO RELATED APPLICATION

This application claims priority to U.S. Provisional Patent Application No. 61/376,531 filed Aug. 24, 2010, the disclosure of which is incorporated herein in its entirety by this reference.

### FIELD OF THE DISCLOSURE

The present disclosure relates to disposable cutlery. In particular, the present disclosure relates to a grouping of utensils including an elongated apparatus to which the utensils may be removably coupled.

### BACKGROUND

Disposable cutlery may be provided as a less expensive alternative to reusable cutlery, for example, at restaurants and social gatherings where it is undesirable or cost prohibitive to clean the cutlery for reuse. However, providing disposable cutlery may present a number of potential drawbacks related to the nature in which it is dispensed.

For example, providing disposable cutlery in a loose or unpackaged fashion, such as in loose form in a receptacle containing the disposable cutlery, may result in patrons taking more cutlery than necessary, thereby increasing the cost of providing the cutlery. In addition, providing loose or unpackaged cutlery may present concerns regarding whether dispensing cutlery in such a manner is hygienic. As a result, it may be desirable to dispense disposable cutlery in a manner other than in a loose or unpackaged form.

The above-noted concerns may be addressed by dispensing disposable cutlery from dispensers configured to contain a supply of the cutlery and dispense a disposable utensil upon operation of a patron. However, loading a quantity of unsecured or loose utensils into the dispenser may be a time consuming and tedious task, thereby potentially undermining the desirability of dispensing utensils via a dispenser.

In addition, it may be desirable to provide utensils that are not prone to flipping or otherwise changing from a desired orientation during either a process of being loaded into a dispenser, or a process of being dispensed from a dispenser. For example, during dispensing of a stack of loose utensils, the utensils may have a tendency to flip or rotate within the dispenser as the stack slides within the dispenser, which may lead to jamming the dispenser, thereby potentially compromising the utility of the dispenser.

Additionally, it may be desirable to provide utensils in a form that are capable of being reliably dispensed from a dispenser in an individual fashion. Utensils that are loosely received in a dispenser may have a tendency to dispense such that more than one utensil is unintentionally dispensed by a patron. This results in compromising one of the potential advantages of dispensing utensils via a dispenser-reducing costs associated with patrons taking more utensils than necessary.

Thus, it is desirable to provide a system and method for addressing one or more of the potential drawbacks discussed above.

### SUMMARY

In the following description, certain aspects and embodiments will become evident. It should be understood that the aspects and embodiments, in their broadest sense, could be practiced without having one or more features of these aspects and embodiments. Thus, it should be understood that these aspects and embodiments are merely exemplary.

One aspect of the disclosure relates to an elongated apparatus for releasably retaining a plurality of utensils in a grouping. The apparatus includes an elongated base having a longitudinal axis and at least one protrusion extending from the elongated base. The at least one protrusion is configured to be removably coupled to a handle end of a utensil such that coupling of the handle end occurs via movement of the handle end along an axis transverse to the longitudinal axis of the elongated base. Upon coupling of the handle end of the utensil to the at least one protrusion, the utensil is restricted from rotating about the longitudinal axis so long as the handle end of the utensil is coupled to the at least one protrusion,

Another aspect of the disclosure relates to a grouping of a plurality of utensils. At least one of the plurality of utensils includes a functional end and a handle associated with the functional end, wherein the handle has a handle end. The grouping also includes an elongated apparatus for releasably retaining the plurality of utensils in the grouping. The elongated apparatus includes an elongated base having a longitudinal axis and at least one protrusion extending from the elongated base. The handle end of the at least one utensil is removably coupled to the apparatus via the at least one protrusion.

Yet another aspect of the disclosure relates to a method for separating a utensil from an elongated apparatus for releasably retaining a plurality of utensils. At least one of the plurality of utensils includes a functional end and a handle associated with the functional end, wherein the handle has a handle end. The handle end of the at least one utensil is removably coupled to the apparatus via the at least one protrusion. The method includes applying a force to the utensil such that the handle end of the utensil is decoupled from the elongated base.

As used herein, the term “parallel” means substantially parallel, and the term “perpendicular” means substantially perpendicular.

### BRIEF DESCRIPTION OF THE DRAWINGS

The accompanying drawings, which are incorporated in and constitute a part of this description, illustrate several exemplary embodiments and together with the description, serve to explain principles of the embodiments. In the drawings,

FIG. 1 is a schematic partial perspective view of an exemplary elongated apparatus and an exemplary utensil.

FIG. 2 is a schematic partial perspective view of an exemplary elongated apparatus and an exemplary utensil.

FIG. 3 is a schematic partial perspective view of an exemplary elongated apparatus and a plurality of exemplary utensils.

FIG. 4 is a schematic partial perspective view of an exemplary elongated apparatus and an exemplary utensil.

FIG. 5 is a schematic partial side view of an exemplary elongated apparatus and a plurality of exemplary utensils.

FIG. 6A is a schematic partial perspective view of an exemplary protrusion including an exemplary ridge.

FIG. 6B is a schematic partial perspective view of an exemplary protrusion including an exemplary ridge.

FIG. 6C is a schematic partial perspective view of an exemplary protrusion including a plurality of exemplary recesses.

FIG. 6D is a schematic partial perspective view of an exemplary protrusion including a plurality of exemplary nodes.

FIG. 7A is a schematic cross-sectional view along line A-A of FIG. 6A.

FIG. 7B is a schematic cross-sectional view similar to FIG. 7A for another exemplary protrusion.

FIG. 7C is a schematic cross-sectional view similar to FIG. 7A for another exemplary protrusion.

FIG. 7D is a schematic cross-sectional view similar to FIG. 7A for another exemplary protrusion.

FIG. 7E is a schematic cross-sectional view similar to FIG. 7A for another exemplary protrusion.

FIG. 7F is a schematic cross-sectional view similar to FIG. 7A for another exemplary protrusion.

FIG. 8A is a schematic partial perspective view showing an exemplary decoupler decoupling an exemplary utensil from a plurality of grouped utensils.

FIG. 8B is a schematic partial perspective view showing an exemplary decoupler decoupling an exemplary utensil from a plurality of grouped utensils.

### DESCRIPTION OF EXEMPLARY EMBODIMENTS

Reference will now be made in detail to exemplary embodiments. Wherever possible, the same reference numbers are used in the drawings and the description to refer to the same or like parts.

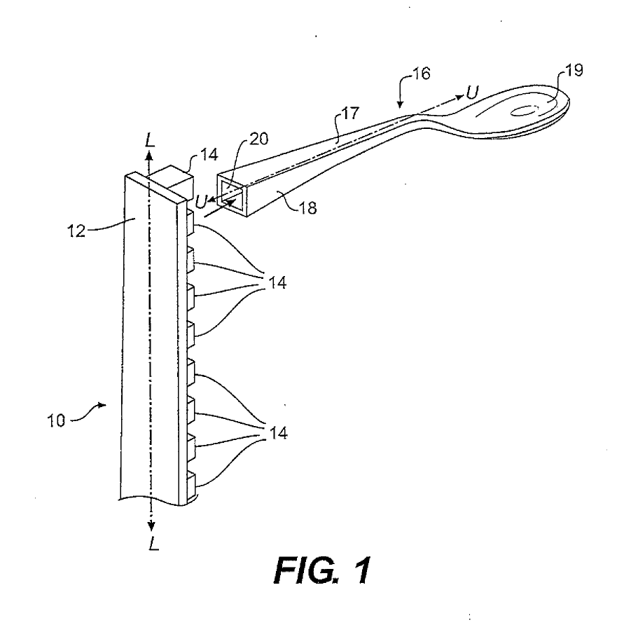

FIG. 1 shows a schematic partial perspective view of an exemplary elongated apparatus 10 for releasably retaining a plurality of utensils 16 in a grouping, and an exemplary utensil 16. For example, as shown in FIG. 1, exemplary elongated apparatus 10 and exemplary utensil 16 are configured to be removably coupled to one another via exemplary protrusion 14. Elongated apparatus 10 includes an elongated base 12. In some embodiments, the elongated base 12 may have a shape that is relatively thin and flat. However, it is anticipated that elongated base 12 may have any shape, such as, for example, a shape that includes ridges along one side of the elongated base 12 that may be used to maintain the positioning of the elongated base 12 within a dispenser. Elongated apparatus 10 includes a longitudinal axis L that extends along the length of elongated apparatus 10.

In some embodiments, elongated apparatus 10 may be constructed from a formable material. The formable material may include, for example, plastic, combinations of plastics, or combinations of plastics and other materials suitable for use as disposable or reusable cutlery. For example, the formable material may include one or more of polystyrene, polyethylene, and polypropylene.

As shown in FIG. 1, elongated base 12 may include at least one protrusion 14 extending from elongated base 12. While FIG. 1 shows nine protrusions 14 extending from elongated base 12, any number of protrusions 14 may extend from elongated base 12, such as, for example, 10, 15, 20, 25, 35, 50, or 100 or more protrusions 14. Protrusions 14 are configured to be removably coupled to at least one utensil 16. According to some embodiments elongated apparatus 10 may be configured to be shortened by, for example, breaking- or cutting-off a portion of the elongated apparatus 10. Such embodiments may facilitate reducing the number of utensils 16 grouped together by elongated apparatus 10.

As shown in FIG. 1, exemplary utensil 16 is a spoon. However, utensil 16 may be any type of utensil, including, for example, a spoon, a fork, a knife, and a spork. In some embodiments, utensil 16 may be constructed from a formable material. The formable material may include, for example, plastic, combinations of plastics, or combinations of plastics and other materials suitable for use as disposable or reusable cutlery. For example, the formable material may include one or more of polystyrene, polyethylene, and polypropylene.

Exemplary utensil 16 includes a handle 17, which may be utilized by a user to hold and/or manipulate utensil 16. Handle 17 includes a handle end 18. Utensil 16 also has a functional end 19, which may be configured to be used to perform a function that assists in the consumption of food, for example, cutting, piercing, and/or scooping. While handle end 18 may be a portion of handle 17, handle end 18 may also encompass all of handle 17.

As shown in FIG. 1, protrusion 14 may be configured to be removably coupled to handle end 18 of utensil 16. In order to facilitate removable coupling, protrusion 14 may be shaped to fit within a portion of handle end 18. For example, in some embodiments, such as the embodiment of FIG. 1, handle end 18 may include at least one opening 20 accessible along a utensil axis U of utensil 16, such that opening 20 is configured to receive at least one protrusion 14.

Coupling of handle end 18 to protrusion 14 may occur via movement of handle end 18 along an axis transverse to longitudinal axis L of elongated base 12. For example, in some embodiments, coupling of handle end 18 to protrusion 14 may occur via movement of handle end 18 along an axis perpendicular to longitudinal axis L. According to some embodiments, coupling may occur via movement of handle end 18 along an axis substantially parallel to longitudinal axis L. In some embodiments, upon coupling of handle end 18 to at least one protrusion 14, utensil 16 is substantially restricted from rotating about longitudinal axis L, so long as handle end 18 remains coupled to protrusion 14.

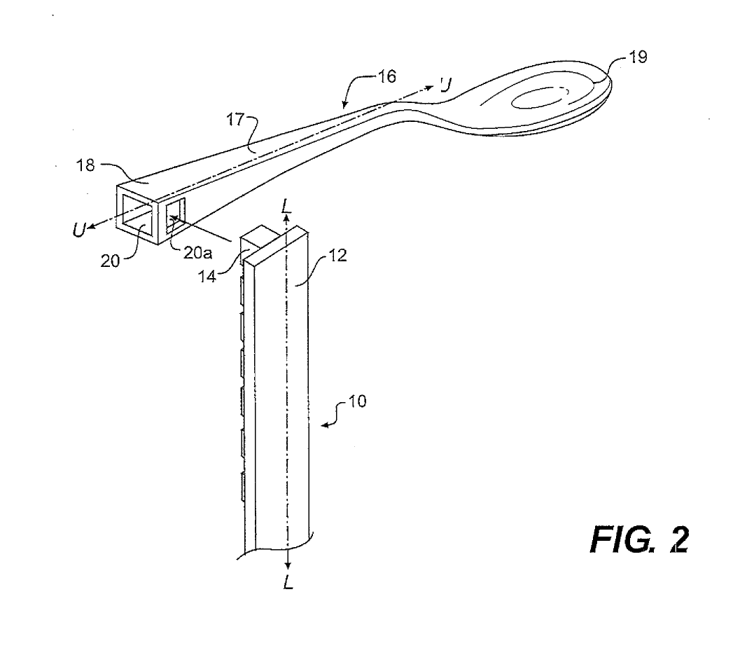

Coupling of handle end 18 to protrusion 14 may occur via movement of handle end 18 along an axis substantially parallel to utensil axis U. In some embodiments, for example, opening 20 may be located at the end of utensil 16, positioned to removably couple to protrusion 14 via movement along an axis substantially parallel to utensil axis U (see, e.g., FIG. 1). According to some embodiments, however, handle end 18 may removably couple with protrusion 14 via movement along an axis that is not substantially parallel to utensil axis U (see, e.g., FIG. 2).

FIG. 2 shows an exemplary utensil 16 configured to be coupled to elongated apparatus 10 via movement in a direction that is not substantially parallel to utensil axis U. Utensil 16 shown in FIG. 2 includes a plurality of openings 20 that may be coupled with protrusions 14. As shown in FIG. 2, utensil 16 may be oriented such that protrusion 14 is capable of coupling with utensil 16 via the opening 20a provided on a lateral side of handle end 18. Upon coupling of handle end 18 to protrusion 14, utensil 16 is restricted from rotating about longitudinal axis L of elongated apparatus 10, so long as handle end 18 remains coupled to protrusion 14.

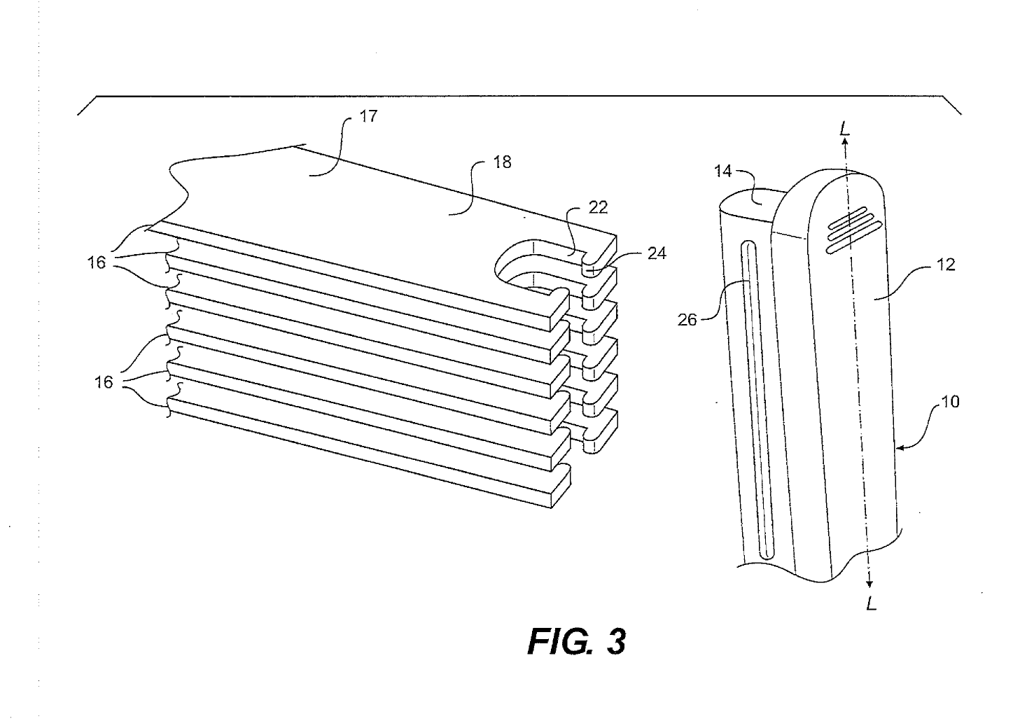

In addition to being removably coupled via an opening, some embodiments of utensil 16 may be configured to be removably coupled with elongated apparatus 10 via a slot. For example, FIG. 3 shows a schematic partial perspective view of a plurality of utensils 16 that include slots 22 configured to be removably coupled to protrusion 14 of elongated apparatus 10. In particular, slot 22 includes a narrow portion 24 configured to engage one or more features of protrusion 14. For example, protrusion 14 may have at least one ridge 26 provided on at least one surface of protrusion 14. According to the embodiment shown in FIG. 3, for example, protrusion 14 may have a ridge 26 on each side of protrusion 14 that extends along protrusion 14 in a direction substantially parallel to longitudinal axis L. Slot 22 of handle end 18 may engage protrusion 14 such that the narrow portion 24 of slot 22 engages ridge 26 and removably couples utensil 16 to elongated apparatus 10. According to some embodiments (not shown) protrusion 14 may have one or more ridges extending in a direction substantially perpendicular to longitudinal axis L. Such ridges may facilitate spacing between utensils on protrusion 14.

Similarly, in some embodiments, protrusion 14 may include a recess (not shown) instead of a ridge 26. In such an embodiment, narrow portion 24 may be configured to fit within the recess and removably couple utensil 16 to elongated apparatus 10. According to some embodiments, slot 22 may be configured to removably couple with protrusion 14 via movement of handle end 18 along an axis transverse to longitudinal axis L. Additionally, slot 22 may removably couple with protrusion 14 via movement of handle end 18 along an axis substantially parallel to longitudinal axis L.

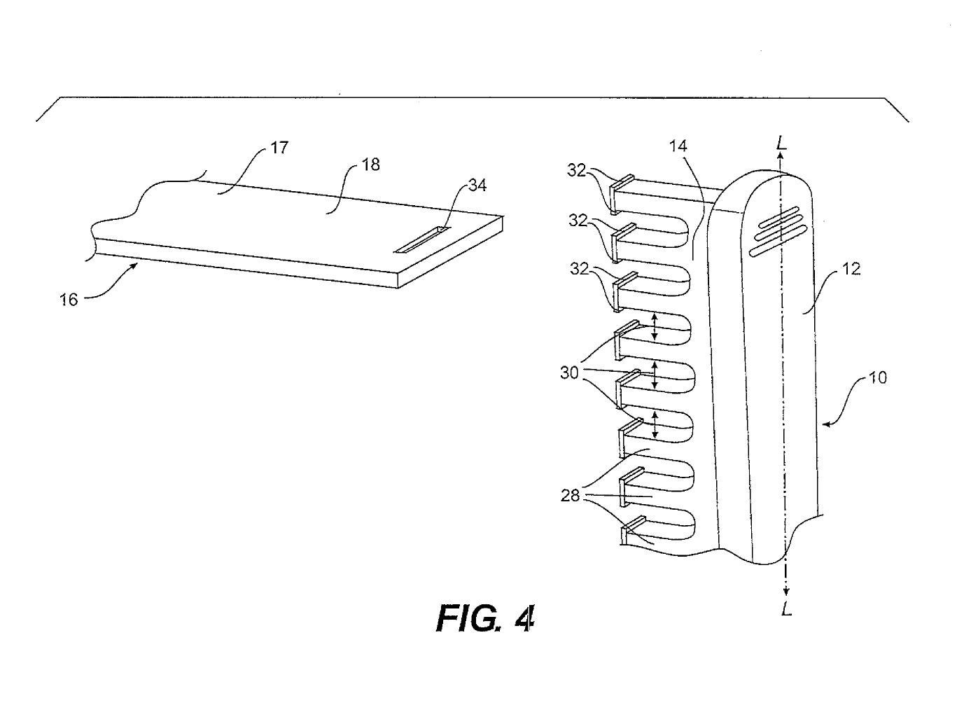

As shown in FIG. 4, elongated apparatus 10 may include at least one protrusion 14 that includes a plurality of peaks 28 configured to receive handle end 18. In some embodiments, for example, the peaks 28 may be shaped such that adjacent peaks 28 form a space 30 configured to receive handle end 18. At least one peak 28 may include at least one node 32 extending from the peak 28. Node 32 may be configured to engage an indentation 34 of handle end 18, such that utensil 16 is removably coupled to elongated apparatus 10. In some embodiments, handle end 18 includes at least one indentation 34 on a plurality of surfaces (e.g., on opposing surfaces) of handle end 18 configured to engage a plurality of nodes 32 simultaneously. Coupling may occur via movement of handle end 18 along an axis transverse to longitudinal axis L. In some embodiments, upon coupling of handle end 18 of utensil 16 to the peaks 28 of elongated apparatus 10, utensil 16 may be restricted from rotating about longitudinal axis L, so long as handle end 18 remains coupled to elongated apparatus 10.

In some embodiments, at least one protrusion 14 may be configured to separably couple utensil 16 to elongated apparatus 10 by receiving handle end 18 in a protrusion opening. The protrusion opening may at least partially surround at least a portion of handle end 18 and restrict utensil 16 from rotating about longitudinal axis L, so long as handle end 18 remains coupled to elongated apparatus 10.

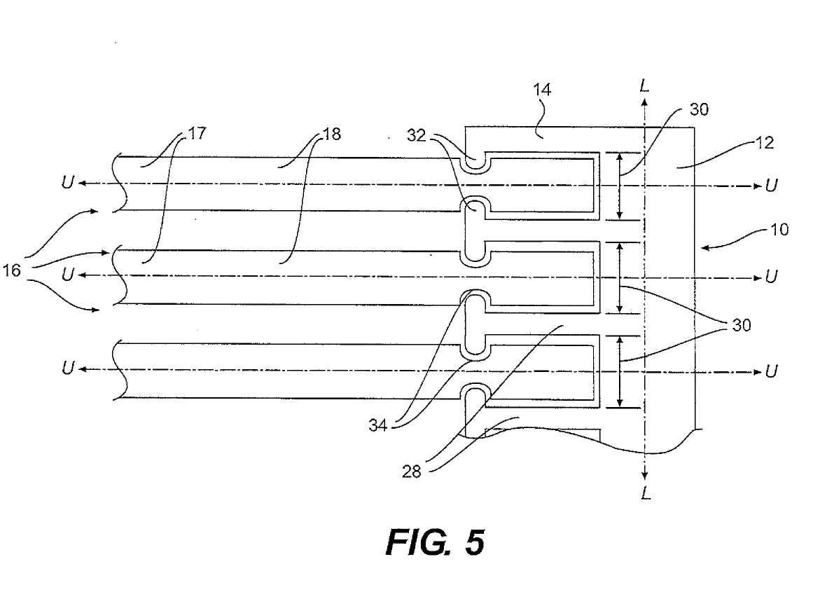

FIG. 5 shows a schematic partial side view of a plurality of exemplary utensils 16 separably coupled to an exemplary elongated apparatus 10. Each utensil 16 is shown coupled to elongated apparatus 10 via nodes 32 extending from peaks 28. Nodes 32 are coupled to the utensils 16 via opposing indentations 34 within handle ends 18.

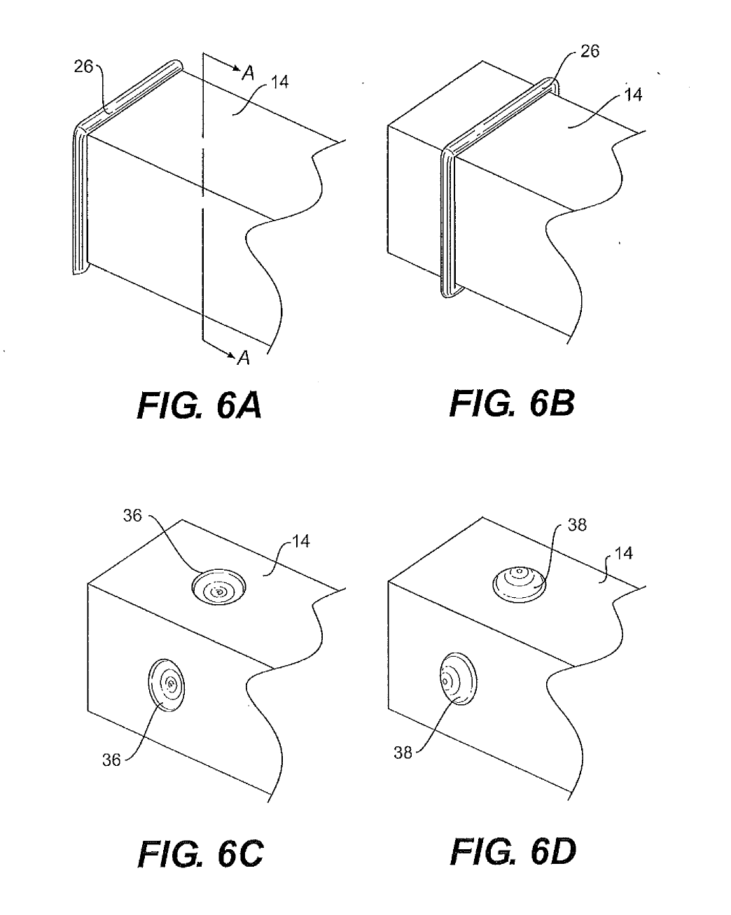

In some embodiments, one or more inner surfaces within a handle end 18 include a recessed area configured to receive a ridge. For example, FIG. 6A shows a schematic partial perspective view of an exemplary protrusion 14 including a ridge 26 configured to engage at least one inner surface of handle end 18 of utensil 16.

While ridge 26 appears at the outer edge of protrusion 14 in FIG. 6A, it may be provided at other locations as well. For example, FIG. 6B shows protrusion 14 having an exemplary ridge 26 provided on a portion of at least two sides of protrusion 14 in a location other than the outer edge. According to some embodiments, depending on the location of ridge 26, protrusion 14 may be configured to separably couple to handle end 18 at various distances from elongated base 12. For example, when ridge 26 is located at the outer edge of protrusion 14, protrusion 14 may be able to engage handle end 18 without being fully inserted into opening 20. On the other hand, when ridge 26 is located closer to elongated base 12, it may be desirable to insert protrusion 14 further into opening 20 in order to engage handle end 18.

According to some embodiments, one or more recesses may be substituted for ridge 26 shown in FIG. 6B. For example, such recesses may be configured to be separably coupled with at least one node (not shown) extending from an inner surface of opening 20. For example, FIG. 6C shows a schematic partial perspective view of a protrusion 14 including a plurality of recesses 36. Recesses 36 are shown have a substantially semi-spherical shape, but may be any shape, including, for example, rectangular or triangular. Alternatively, for example, as shown in FIG. 6D, protrusion 14 may include a plurality of nodes 38 configured to engage recesses located on the inner surface of opening 20.

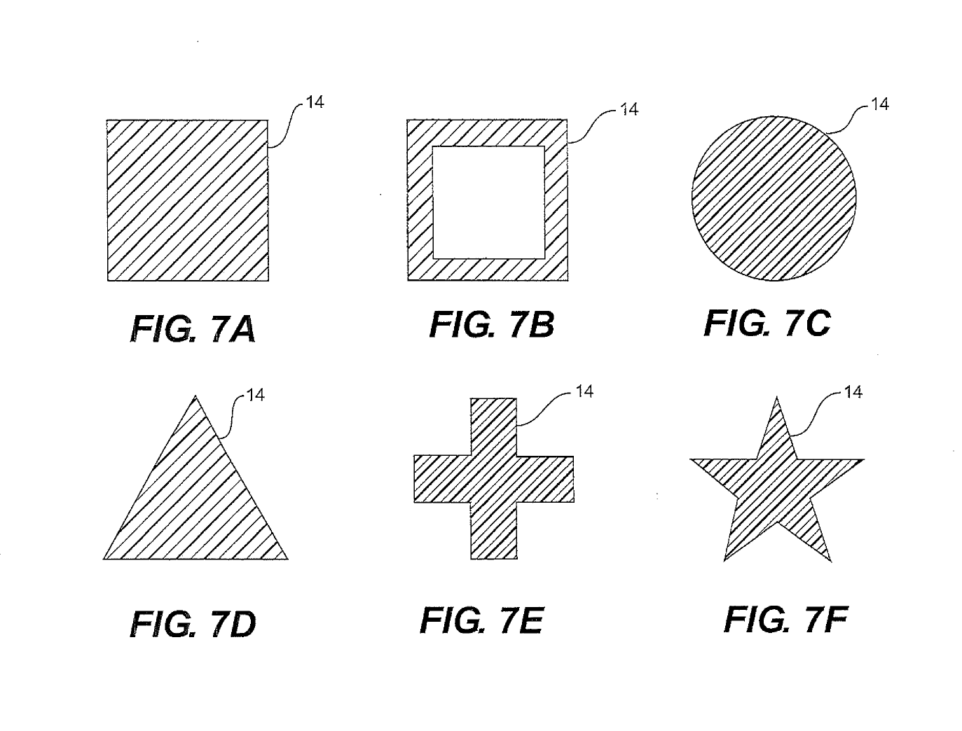

FIGS. 7A-7F show cross-sectional views of exemplary protrusions 14. For example, FIG. 7A shows a cross-section of the exemplary protrusion 14 shown in FIG. 6A along line A-A, with protrusion 14 having a solid rectangular cross-sectional shape. The protrusion 14 of FIG. 7A may be configured to couple with, for example, opening 20 of handle end 18 shown in FIG. 1 or 2. While protrusion 14 of FIG. 7A has a solid cross-sectional shape, protrusion 14 may also be hollow, as shown, for example, in FIG. 7B. According to some embodiments, protrusion 14 of FIG. 7B may be removably coupled to a handle end 18 that includes a solid cross-sectional shape. For example, handle end 18 may be solid with a portion of the handle end 18 shaped to engage the interior of the hollow portion of protrusion 14 of FIG. 7B.

Although FIGS. 7A and 7B show protrusions 14 having substantially rectangular cross-sectional shapes, it is contemplated that protrusions 14 may be provided in other cross-sectional shapes. For example, FIG. 7C shows a schematic cross-sectional view of a protrusion 14 that has a round cross-section. Although the protrusion 14 of FIG. 7C is shown having a solid cross section, it may also be hollow. FIG. 7D shows a schematic cross-sectional view of a protrusion 14 that has a triangular cross-section. According to some embodiments, protrusion 14 of FIG. 7D may be hollow. FIG. 7E shows a schematic cross-sectional view of an exemplary protrusion 14 that has a plus-shaped cross-section. FIG. 7F shows a schematic cross-sectional view of an exemplary protrusion 14 that has a star-shaped cross-section. The exemplary protrusions shown in FIGS. 7D-7F may have hollow cross-sections. Regardless of the cross-sectional shape of protrusion 14, opening 20 of handle end 18 may be shaped to separably couple with protrusion 14.

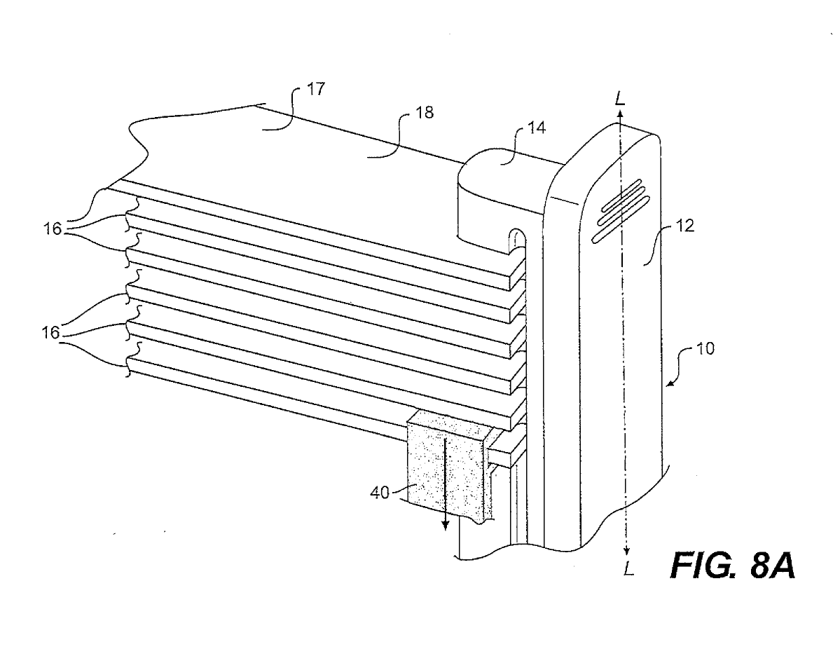

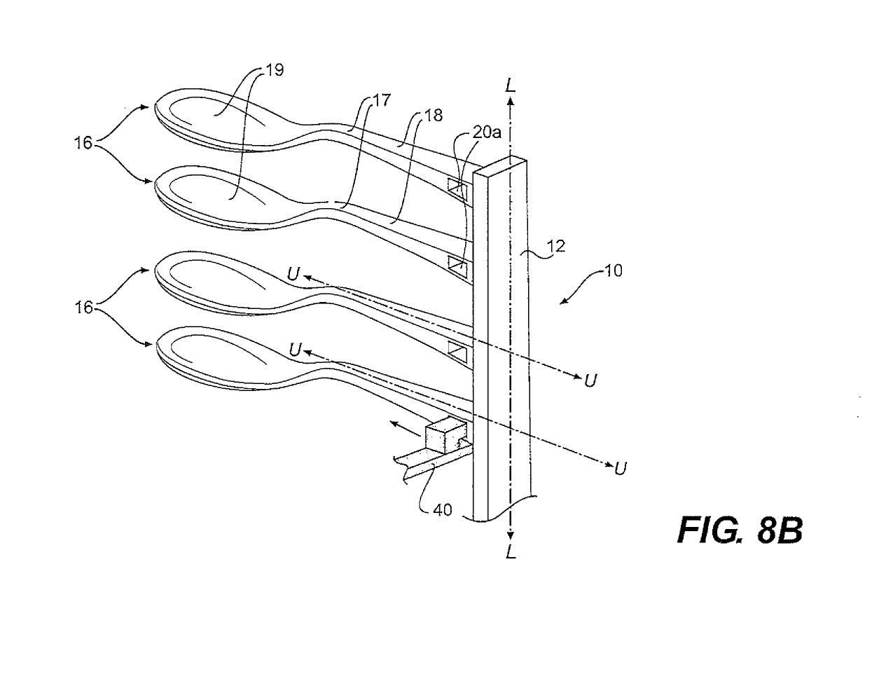

FIGS. 8A and 8B show schematic perspective views of exemplary groups of separably coupled utensils 16 undergoing an exemplary decoupling and/or dispensing process. In FIG. 8A, for example, exemplary decoupler 40 is shown applying force to an exemplary utensil 16 in order to decouple utensil 16 from exemplary elongated apparatus 10. According to some embodiments, decoupler 40 may be configured to apply force to utensil 16 in a direction substantially parallel to longitudinal axis L, such that utensil 16 slides off protrusion 14, separating utensil 16 from protrusion 14. Such a decoupler 40 may have a claw- or clamp-shaped head, such that it abuts at least one surface of utensil 16. Alternatively, decoupler 40 may include a generally wedge-shaped head configured to be inserted between two utensils 16. For example, the size and/or shape of the head of decoupler 40 may force the utensils 16 on either side of the head in opposite directions, thereby separating at least one of the utensils 16 from elongated apparatus 10. According to some embodiments, decoupler 40 may separate utensil 16 from elongated apparatus 10 by severing at least a portion of one or more protrusions 14, with which utensil 16 is coupled.

In FIG. 8B, exemplary decoupler 40 is shown applying force to an exemplary utensil 16 in a direction substantially parallel to utensil axis U. By applying force in a direction substantially parallel to utensil axis U, decoupler 40 may separate utensil 16 from protrusion 14 without separating protrusion 14 from elongated apparatus 10. In some embodiments, however, exemplary decoupler 40 may apply a force to utensil 16 in a direction that separates at least a portion of at least one protrusion 14 from elongated apparatus 10. In the embodiment shown in FIG. 8B, exemplary decoupler 40 engages utensil 16 via at least one opening 20a in a lateral side of utensil 16.

It is contemplated that decoupling force may be applied to any number of utensils 16 in any number of directions. According to some embodiments, a plurality of decouplers 40 may be used individually, or in combination, to decouple utensils 16 from exemplary elongated apparatus 10. According to some embodiments, if at least one protrusion 14 is separated from elongated base 12, then protrusion 14 may remain inside handle end 18 or may be deposited into a receptacle for storage, recycling, or waste.

According to some embodiments, decoupler 40 may be part of a dispenser (not shown) for dispensing individual utensils 16. Such a dispenser may utilize a decoupler 40 to decouple utensils 16 either individually or in groups. The dispenser may also hold one or more types of utensils 16, including, for example, at least one of a spoon, a fork, a knife, and a spork.

In some embodiments, utensils 16 may be separated from elongated apparatus 10 without the use of decoupler 40. For example, elongated apparatus 10 may be removed by hand, for example, after utensils 16 have been loaded into a dispenser in a manner that will facilitate dispensing by the dispenser. For example, a grouping of a plurality of utensils 16 comprising elongated apparatus 10 may be loaded into a dispenser with elongated apparatus 10 coupled to the plurality of utensils 16. Once the plurality of utensils 16 is positioned in a desired manner in the dispenser, elongated apparatus 10 may remain in the dispenser during dispensing until the plurality of utensils 16 are depleted and prior to loading another grouping of utensils into the dispenser, or elongated apparatus 10 may be decoupled (e.g., by hand) from the plurality of utensils 16 once the utensils 16 have been loaded into the dispenser, but prior to dispensing any of the utensils 16.

It will be apparent to those skilled in the art that various modifications and variations can be made to the structures and methodologies described herein. Thus, it should be understood that the invention is not limited to the subject matter discussed in the description. Rather, the present disclosure is intended to cover modifications and variations.

What is claimed is:

1. An elongated apparatus for releasably retaining a plurality of utensils in a grouping, the apparatus comprising:
an elongated base having a longitudinal axis; and
at least one protrusion extending from the elongated base,
wherein the at least one protrusion is configured to be removably coupled to a handle end of a utensil,
wherein coupling of the handle end of the utensil occurs via movement of the handle end along an axis transverse to the longitudinal axis of the elongated base, and
wherein upon coupling of the handle end of the utensil to the at least one protrusion, the utensil is restricted from rotating about the longitudinal axis so long as the handle end of the utensil is coupled to the at least one protrusion.

2. The apparatus of claim 1, wherein the at least one protrusion comprises a ridge configured to removably couple the utensil to the elongated apparatus,

3. The apparatus of claim 1, wherein the at least one protrusion comprises a recess configured to removably couple the utensil to the elongated apparatus.

4. The apparatus of claim 1, wherein the at least one protrusion comprises at least one slot configured to removably couple the utensil to the elongated apparatus.

5. The apparatus of claim 1, wherein the at least one protrusion comprises at least one of a rectangular-shaped, round-shaped, triangular-shaped, star-shaped, and plus-shaped cross-section.

6. The apparatus of claim 1, wherein coupling of the handle end of the utensil occurs via movement of the handle end along an axis perpendicular to the longitudinal axis of the elongated base.

7. A grouping of a plurality of utensils, comprising:
a plurality of utensils, at least one of the utensils comprising:
a functional end; and
a handle associated with the functional end, the handle having a handle end; and
an elongated apparatus for releasably retaining the plurality of utensils in the grouping, the elongated apparatus comprising:
an elongated base having a longitudinal axis; and
at least one protrusion extending from the elongated base,
wherein the handle end of the at least one utensil is removably coupled to the apparatus via the at least one protrusion.

8. The grouping of claim 7, wherein the at least one protrusion comprises a ridge configured to removably couple the at least one utensil to the elongated apparatus.

9. The grouping of claim 7, wherein the at least one protrusion comprises a recess configured to removably couple the at least one utensil to the elongated apparatus.

10. The grouping of claim 7, wherein the at least one protrusion comprises an opening shaped to at least partially surround a portion of the at least one utensil and removably couple the at least one utensil to the elongated apparatus.

11. The grouping of claim 7, wherein the at least one protrusion is shaped such that a space between adjacent portions of the protrusion is configured to removably couple the at least one utensil to the elongated apparatus.

12. The grouping of claim 7, wherein at least a portion of the handle end is hollow, and
wherein the at least one protrusion is configured to fit within an opening in the handle end and removably couple the at least one utensil to the elongated apparatus.

13. The grouping of claim 12, wherein the handle end comprises an opening accessible along a longitudinal axis of the handle and associated with a tip of the handle end, and
wherein the at least one protrusion is configured to fit within the opening.

14. The grouping of claim 12, wherein the handle end comprises an opening associated with a lateral side of the handle end, and
wherein the at least one protrusion is configured to fit within the opening.

15. The grouping of claim 12, wherein at least one inside surface of the handle end comprises a ridge configured to engage the at least one protrusion.

16. The grouping of claim 12, wherein at least one inside surface of the handle end comprises a recess configured to engage the at least one protrusion.

17. The grouping of claim 7, wherein the handle end comprises a slot along a utensil axis, and
wherein the slot is configured to removably couple the at least one utensil to the elongated apparatus by fitting at least partially around the at least one protrusion.

18. The grouping of claim 17, wherein the at least one protrusion comprises a ridge, and
wherein the slot comprises a narrow portion configured to engage the ridge of the at least one protrusion such that the at least one utensil and the at least one protrusion are removably coupled to one another.

19. The grouping of claim 17, wherein the at least one protrusion comprises a recess, and
wherein the slot comprises a narrow portion configured to engage the recess of the at least one protrusion such that the at least one utensil and the at least one protrusion are removably coupled to one another.

20. The grouping of claim 7, wherein the at least one protrusion comprises a plurality of peaks configured to receive the handle end and removably couple the at least one utensil to the at least one protrusion via adjacent peaks.

21. The grouping of claim 7, wherein the at least one protrusion comprises at least one of a rectangular-shaped, round-shaped, triangular-shaped, star-shaped, and plus-shaped cross-section.

22. The grouping of claim 7, wherein at least one of the plurality of utensils comprises a utensil axis, and
wherein the handle end of the at least one utensil is removably coupled to the elongated apparatus via movement in a direction substantially parallel to the utensil axis.

23. The grouping of claim 7, wherein at least one of the plurality of utensils comprises a utensil axis, and
wherein the handle end of the at least one utensil is removably coupled to the elongated apparatus via movement in a direction transverse to the utensil axis.

24. The grouping of claim 23, wherein at least one of the plurality of utensils comprises a utensil axis, and
wherein the handle end of the at least one utensil is removably coupled to the elongated apparatus via movement in a direction perpendicular to the utensil axis.

25. The grouping of claim 7, wherein the handle end of the at least one utensil comprises a slot configured to removably couple the handle end to the elongated apparatus.

26. The grouping of claim 7, wherein upon coupling of the handle end of the at least one utensil to the apparatus, the utensil is restricted from rotating about the longitudinal axis so long as the handle end of the utensil is coupled to the at least one protrusion.

27. A method for dispensing a utensil from the grouping of utensils of claim 7, the method comprising:
applying a force to the utensil such that the handle end of the utensil is decoupled from the at least one protrusion; and
dispensing the decoupled utensil.

28. A method for separating a utensil from an elongated apparatus for releasably retaining a plurality of utensils, wherein the utensil comprises:
a functional end; and
a handle associated with the functional end, the handle having a handle end; and
wherein the elongated apparatus for releasably retaining the plurality of utensils comprises:
an elongated base having a longitudinal axis; and
at least one protrusion extending from the elongated base,
wherein the handle end of the at least one utensil is removably coupled to the apparatus via the at least one protrusion, and
wherein the method comprises:
applying a force to the utensil such that the handle end of the utensil is decoupled from the elongated apparatus.

29. The method of claim 28, wherein applying a force comprises decoupling the utensil from the at least one protrusion.

30. The method of claim 28, wherein applying a force comprises decoupling at least a portion of the at least one protrusion from the elongated base.

31. The method of claim 28, wherein applying a force comprises decoupling at least one protrusion from the elongated base such that the at least one protrusion remains coupled to the utensil.
